(19) United States
(12) Patent Application Publication
(10) Pub. No.: US 2005/0083404 A1
(43) Pub. Date: Apr. 21, 2005

(54) Data acquisition and display system and method of operating the same

(76) Inventors: Keith E. Pierce, Stilwell, KS (US); Charles A. Ross SR., Overland Park, KS (US); David C. Owen, Olathe, KS (US); Laura E. Owen, Olathe, KS (US)

Correspondence Address: BLACKWELL SANDERS PEPER MARTIN LLP, 4801 Main Street, Suite 1000, KANSAS CITY, MO, 64112, US

(21) Appl. No.: 10/926,721

(22) Filed: Aug. 26, 2004

Related U.S. Application Data
(60) Provisional application No. 60/498,035, filed on Aug. 26, 2003.

(30) Foreign Application Priority Data
Oct. 1, 2003 (WO) PCT/US03/30963

(51) Int. Cl. H04N 7/18

(52) U.S. Cl. 348/148

(57) ABSTRACT

A data acquisition recording and display system for mounting in a vehicle having an interior console and an aperture in the console. The system comprising a frame mountable in the aperture. A recording media housed in the frame and operable to store and retrieve audio/video and other data. The content of the recording media being transferable to enable storage and searching on a remote device. Searching being performed with a search engine application.

### RELATED APPLICATIONS

This application is related to and claims priority from provisional application Ser. No. 60/498,065, titled DATA ACQUISITION AND DISPLAY SYSTEM AND METHOD OF OPERATING THE SAME, filed on Aug. 26, 2003.

### FIELD OF THE INVENTION

The present invention relates to a data acquisition and display system and a method for recording, and more particularly to a vehicle mounted data acquisition and display system and a method of digitally recording and storing data in a vehicle mounted apparatus.

### BACKGROUND OF THE INVENTION

It has become increasingly common for police patrol cars to be equipped with complex electronic apparatus, including flashing lights, advanced radar-based speed measuring apparatus, and advanced laser-based speed measuring apparatus. Additionally, in some cases, police patrol cars are equipped with cameras and VCRs for recording video data collected by the cameras. Typically, some or all of these electronic apparatus are mounted in the trunk of the patrol cars.

### SUMMARY OF THE INVENTION

While the above described electronics apparatus are generally useful, law enforcement officers (“officers”) are often unable to effectively operate the electronic apparatus because they are located in hard-to-reach locations and/or are overly complex and difficult to operate. Moreover, it is often difficult for officers to operate the electronic apparatus during high-speed pursuits, domestic disturbances, and other high-stress and high-activity situations. Therefore, the electronic apparatus, and particularly the cameras, are often not activated until after an incident is resolved. For these reasons, the electronic apparatus are often underutilized and valuable data, including video data and speed data, is often not recorded.

Also, conventional electronic apparatus often record a voluminous amount of data, at least some of which is of no real value. Moreover, electronically collected data is often difficult to organize, retrieve, warehouse, and sort and therefore may be of little value.

Additionally, there is an increasing demand for apparatus that monitor and record the activity of police officers and/or suspects during arrests, altercations, vehicle searches, and traffic stops. More particularly, it is thought that by recording the activities of officers and suspects, incidents of police brutality and false allegations of police brutality can be reduced and/or eliminated.

To address these and other concerns, the present invention provides, among other things, a video recording apparatus for mounting in a vehicle having an interior console and an aperture in the console. The apparatus comprises a frame mountable in the aperture, recording media housed in the frame and operable to store video data, and a video input in communication with the recording media to receive video data and to transfer the video data to the recording media.

The present invention also provides a video recording apparatus for mounting in a vehicle having an interior console. The apparatus comprises a frame mountable in the console and housing a radio, a recording media housed in the frame and operable to store video data, and a video input in communication with the recording media to receive video data and to transfer the video data to the recording media.

Additionally, the present invention provides a video recording apparatus for mounting in a vehicle. The apparatus comprises a digital memory unit operable to store video data, a global positioning system operable to calculate location data and being in communication with the digital memory unit to transfer the location data to the digital memory unit, the digital memory unit associating the location data and the video data, and a search engine in communication with the digital memory unit and operable to search the digital memory unit for at least one of the location data and the video data.

Moreover, the present invention provides a video recording apparatus having a digital memory unit operable to store video data, a traffic velocity recording apparatus input in communication with the digital memory unit to receive traffic velocity data and to transfer the traffic velocity data to the digital memory unit, the digital memory unit associating the traffic velocity data and the video data, and a search engine in communication with the digital memory unit and operable to search the digital memory unit for at least one of the traffic velocity data and the video data.

Also, the present invention provides a video recording apparatus having a digital memory unit operable to store video data, a vehicle status data input in communication with the digital memory unit to receive vehicle status data and to transfer the vehicle status data to the digital memory unit, the digital memory unit associating the vehicle status data and the video data, and a search engine in communication with the digital memory unit and operable to search the digital memory unit for at least one of the vehicle status data and the video data.

Additionally, the present invention provides a method of operating a video recording apparatus and a method of recording and indexing data.

Other features and advantages of the invention will become apparent to those skilled in the art upon review of the following detailed description and drawings.

### BRIEF DESCRIPTION OF THE DRAWINGS

The present invention is further described with reference to the accompanying drawings, which show various constructions of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

FIG. 1 is a perspective view of a vehicle and a data acquisition and display system according to the present invention.

FIG. 2 is a front view of a vehicle console supporting a portion of the data acquisition and display system shown in FIG. 1.

FIG. 3 is a schematic illustrating the data acquisition and display system shown in FIG. 1.

FIG. 4A is a front view of a portion of the data acquisition and display system shown in FIG. 1 with a front panel in a closed position.

FIG. 4B is a side view of a portion of the data acquisition and display system shown in FIG. 1 with the front panel in a closed position.

FIG. 5A is a front view of a portion of the data acquisition and display system shown in FIG. 1 with the front panel in an opened position.

FIG. 5B is a side view of a portion of the data acquisition and display system shown in FIG. 1 with the front panel in an opened position.

FIG. 5C is a top view of the data acquisition and display system shown in FIG. 1, showing top view revealing latching mechanism for the front panel.

FIG. 6 is a rear perspective view of a portion of the data acquisition and display system shown in FIG. 1.

FIG. 7A is a front view of a junction box of the data acquisition and display system shown in FIG. 1.

FIG. 7B is a rear view of a junction box of the data acquisition and display system shown in FIG. 1.

FIG. 7C is a left side view of a junction box of the data acquisition and display system shown in FIG. 1.

FIG. 7D is a right side view of a junction box of the data acquisition and display system shown in FIG. 1.

FIG. 7E is a top view of a junction box of the data acquisition and display system shown in FIG. 1.

FIGS. 8A and 8B are perspective views of a video camera of the data acquisition and display system shown in FIG. 1.

FIG. 9 is a perspective view of an external communication system of the data acquisition and display system shown in FIG. 1.

FIG. 10 is a perspective view of a central storage unit for use with the data acquisition and display system shown in FIG. 1.

FIGS. 11A-11C are flowcharts illustrating operation of a data acquisition and display system according to the present invention.

FIGS. 12A-12C illustrate an alternate construction of the vehicle and a data acquisition and display system according to the present invention.

### DETAILED DESCRIPTION

The terms “first”, “second”, “third”, “right”, “left”, “forward”, and “rearward” are used herein and in the claims for purposes of description only and are not intended to imply any particular order, orientation, or importance.

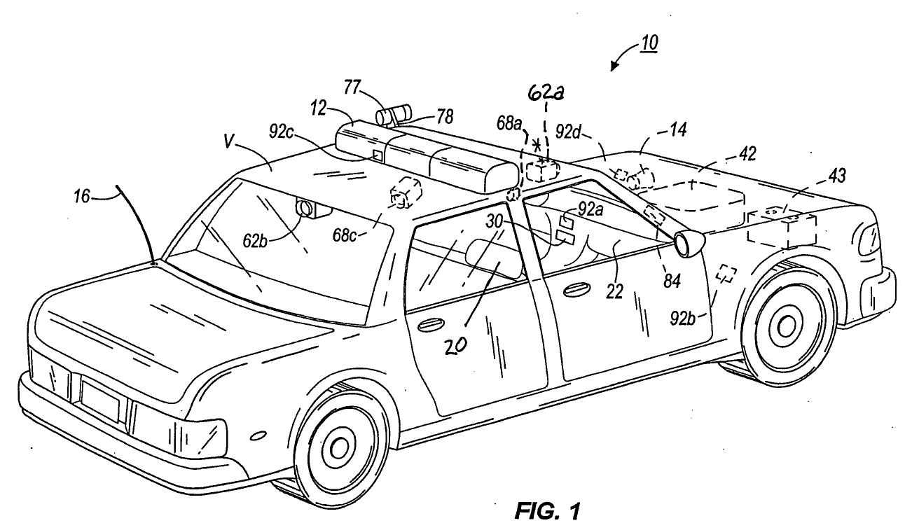

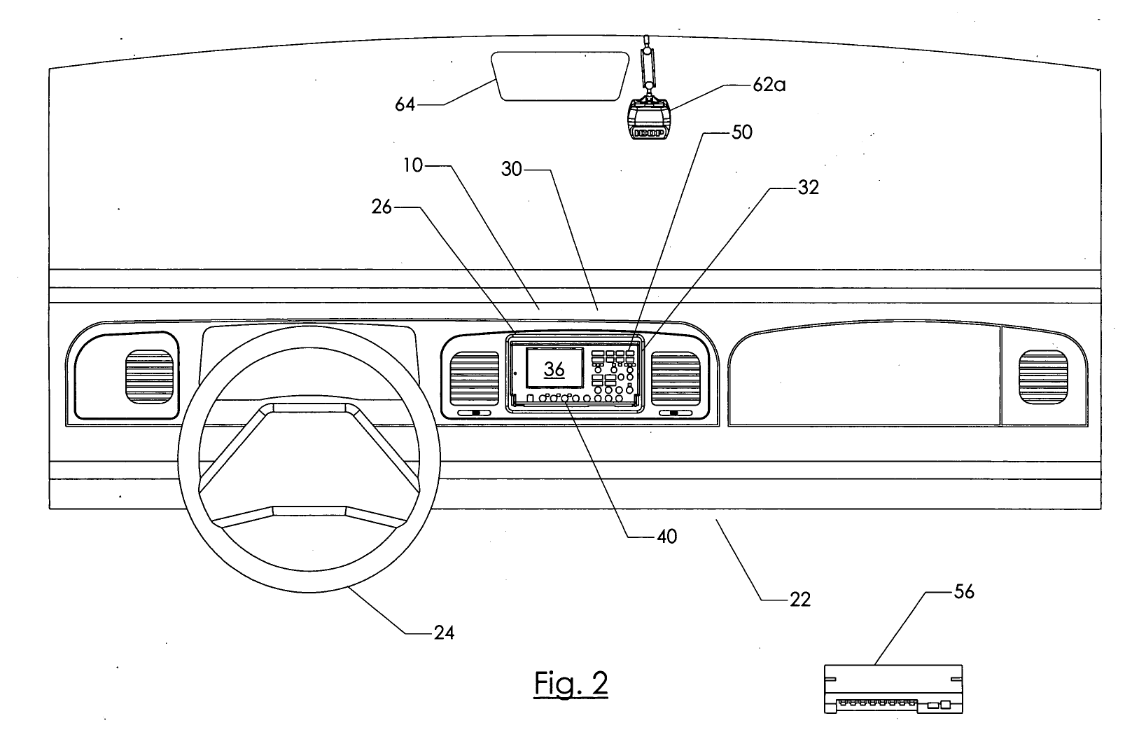

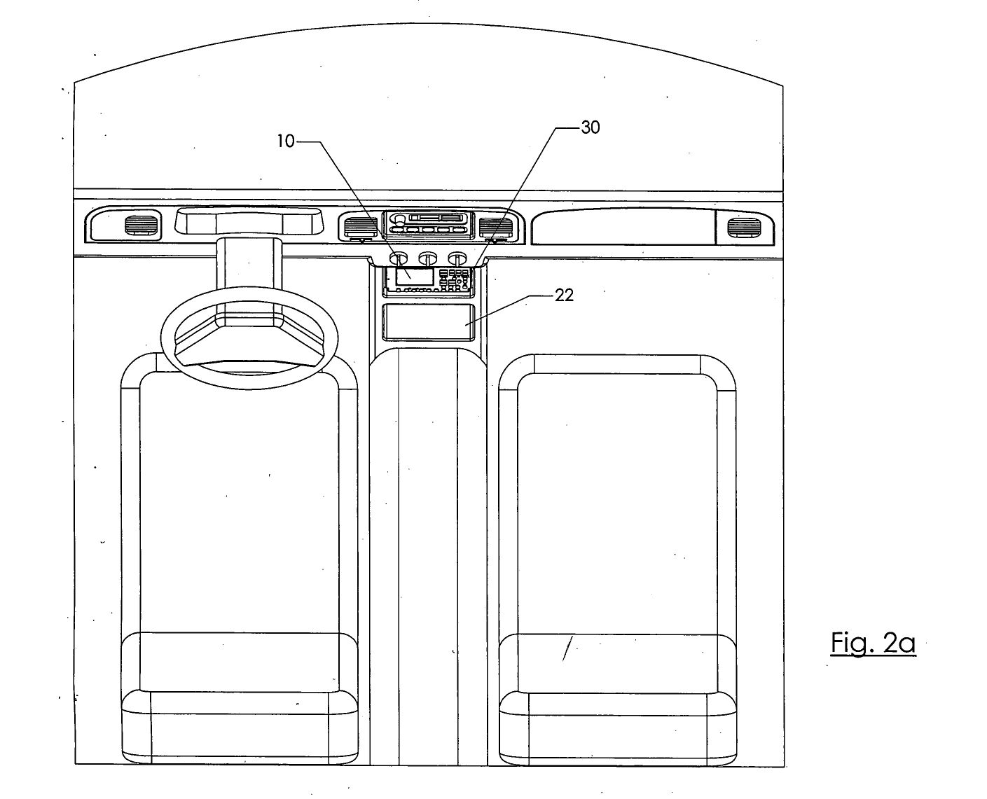

FIGS. 1 and 2 illustrate a vehicle V supporting a data acquisition and display system or audio/video recording apparatus 10 according to the present invention. In the illustrated construction, the vehicle V is a conventional police car (e.g., a Ford Police Interceptor, a Chevrolet Impala, etc.) with a roof mounted light bar 12, a siren 14, and an outboard antenna 16. However, in other constructions (not shown), the data acquisition and display system 10 of the present invention can alternatively be mounted on other motorized and non-motorized vehicles, such as, for example, vans, sport utility vehicles, trucks, motorcycles, airplanes, helicopters, and trailers. Additionally, while reference is made herein and in the figures to law enforcement vehicles, the data acquisition and display system 10 of the present invention can also be used with other vehicles (not shown), such as, for example, customs, department of natural resources (DNR), drug enforcement agency (DEA), ambulances, fire and rescue vehicles, and military vehicles.

The vehicle V includes a driver seat 20 and an instrument console 22 positioned adjacent to the driver seat 20 and the steering wheel 24. In the illustrated construction, the instrument console 22 is supported on the vehicle V dashboard. However, in other constructions (not shown), the instrument console 22 or portions of the instrument console 22 can be positioned between the front seats of the vehicle V or on the vehicle ceiling. The invention will generally be described with respect to an embodiment wherein the audio-video recording apparatus 10 is located within the instrument console 22 supported on the dashboard. However, as would be appreciated by one skilled in the art, apparatus 10 can be located in any one of a plurality of locations about or adjacent to the console. Such locations include, but are not limited to, in the console or dash, underneath the console or dash, above the console or dash or protruding from the console or dash.

As shown in FIG. 2, in the embodiment of the present invention, a central portion of the console 22 defines an aperture 26 adjacent to the steering wheel 24. In the illustrated construction, the aperture 26 is a double-din bin provided according to vehicle manufacturer specifications and is designed to support one or more of a car stereo, a compact disk player, a cassette player, a storage bin, an airbag, a global positioning system, a DVD player, an ash tray, a vehicle climate controller, a vehicle computer, and other peripheral devices. More particularly, in the illustrated construction, the aperture 26 has the dimensions of the manufacturer provided double-din bin in a Ford Police Interceptor and is approximately 7.19 inches wide, 3.61 inches high, and 6.50 inches deep. In other constructions (not shown), the aperture 26 can be added to the vehicle V as an after-market modification and can have other dimensions. In still other constructions (not shown), the aperture 26 can be the vehicle's glove compartment.

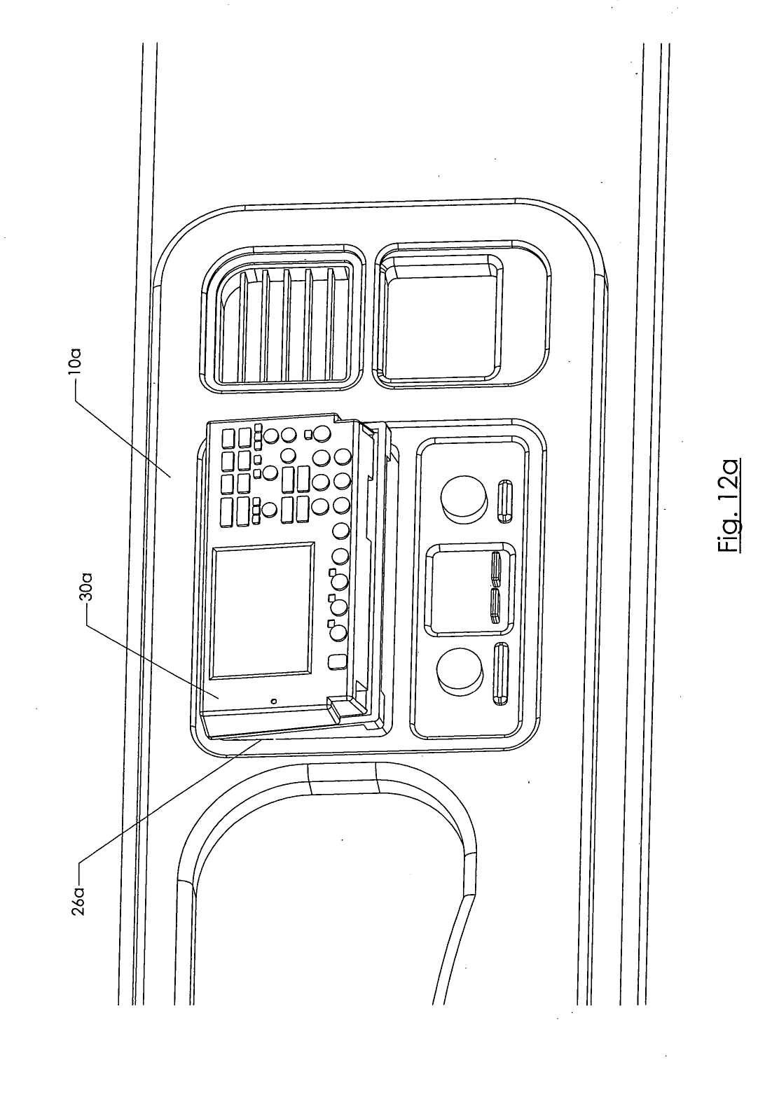

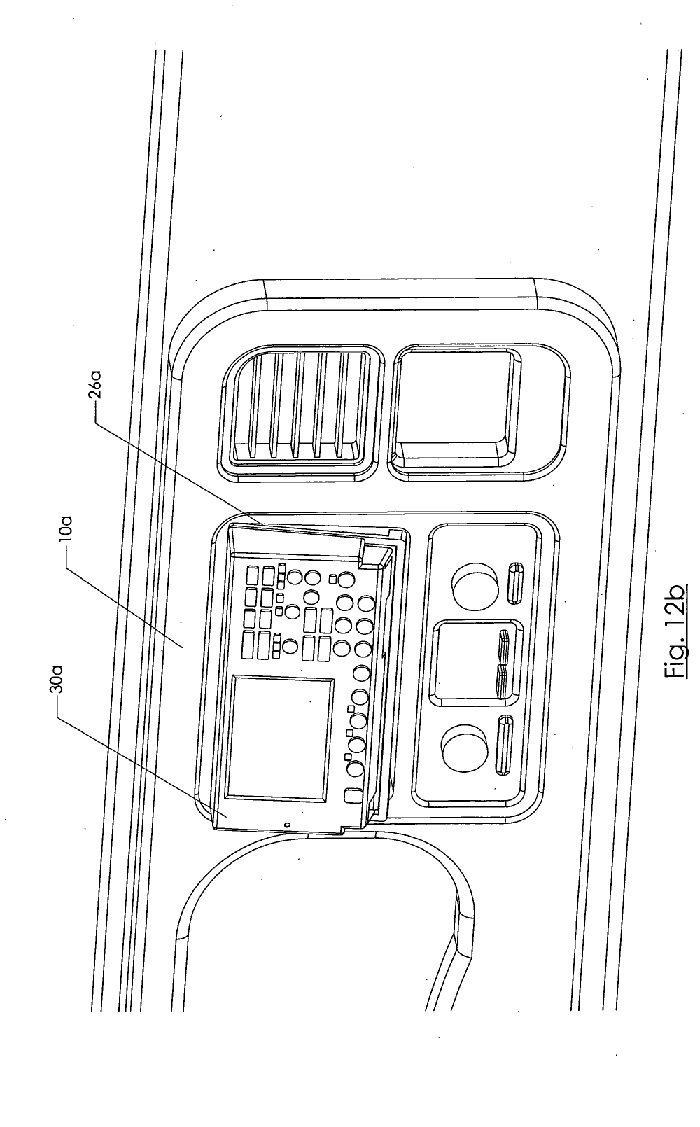

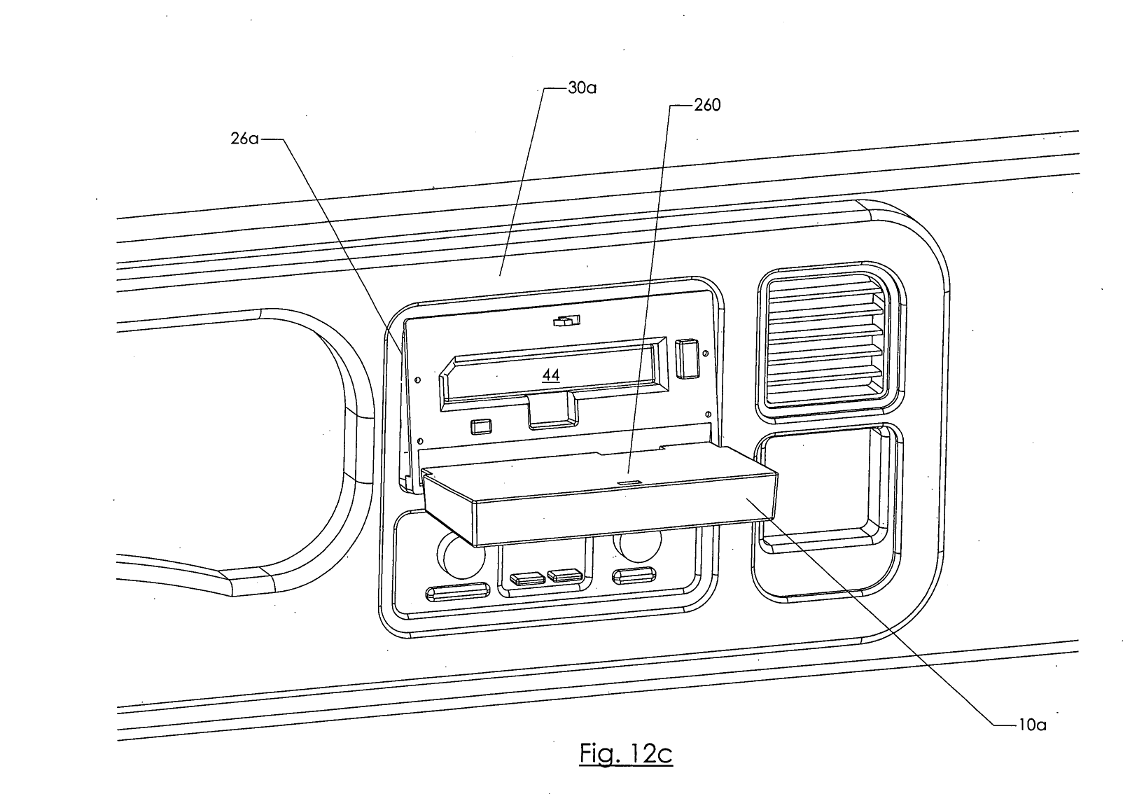

The data acquisition and display system 10 includes a central unit 30 having a frame and being positioned in the aperture 26. In some constructions, the central unit 30 is sized to be received in the double-din bins of vehicles commonly used for law enforcement, such as, for example, the Ford Police Interceptor. In other constructions (as shown in FIGS. 12A-12C), the central unit 30 is sized to be received in other apertures in other vehicles (e.g., the Chevrolet Tahoe). In this manner, the central unit 30 can be installed in a vehicle V without requiring that costly and time-consuming modifications be made to the vehicle V. More particularly, in the illustrated construction, the central unit 30 is approximately 7.10 inches wide, 3.55 inches high, and 6.45 inches long and is sized to be received in the double-din bin of a Ford Police Interceptor.

The central unit 30 houses a central processing unit or controller 31, which is programmable to coordinate operation of the data acquisition and display system 10. Additionally, the controller 31 includes a search engine (not shown), which is operable to search a recording media 44 (described below). A shock absorption and vibration isolation system (not shown) supports the central unit 30 in the console 22 and protects the components housed in the central unit 30 from damage.

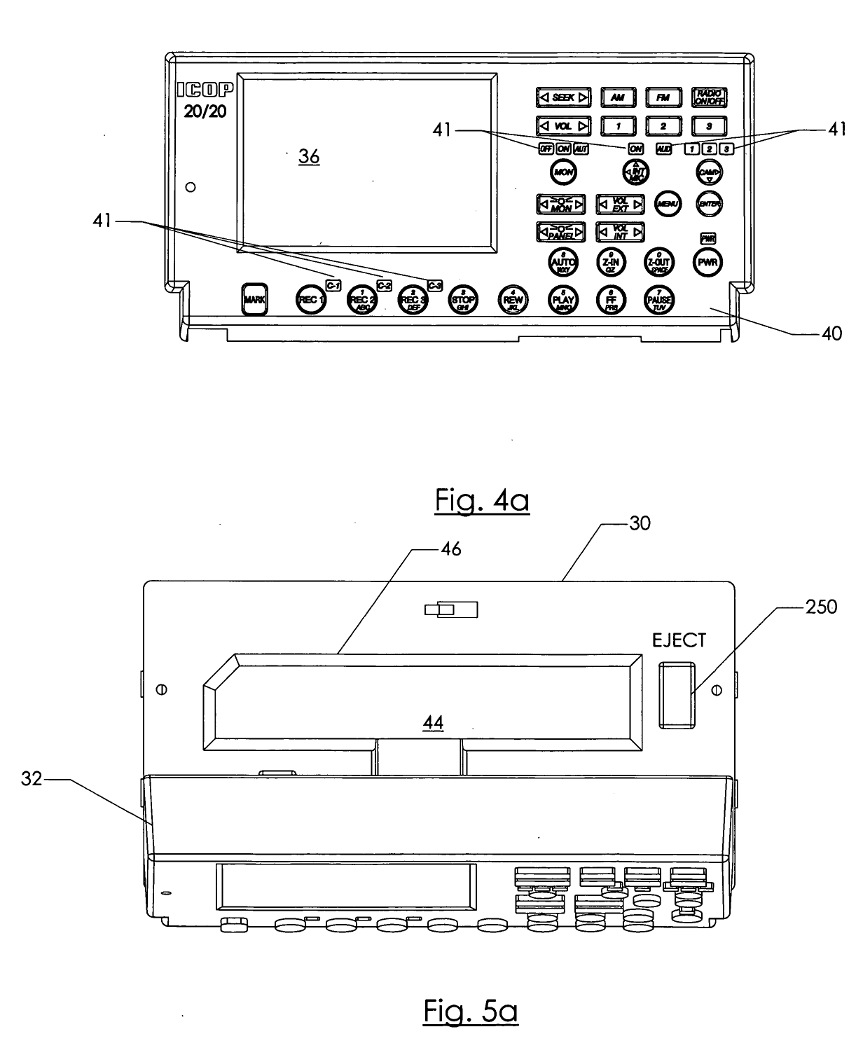

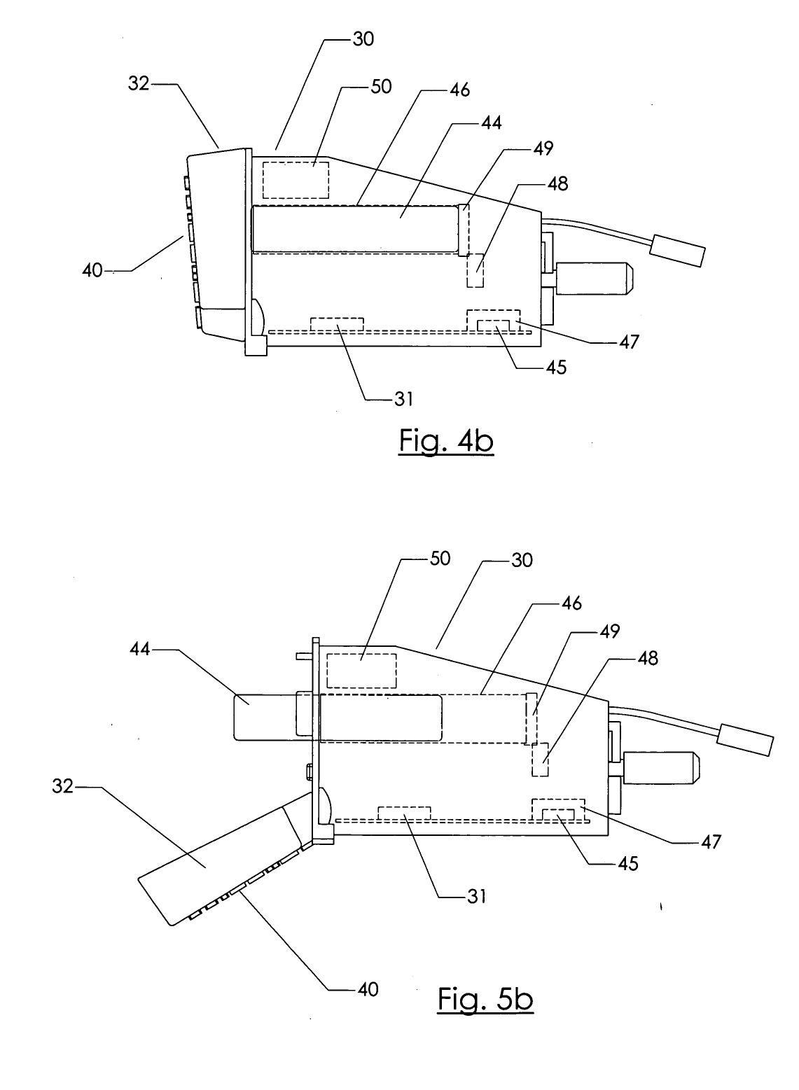

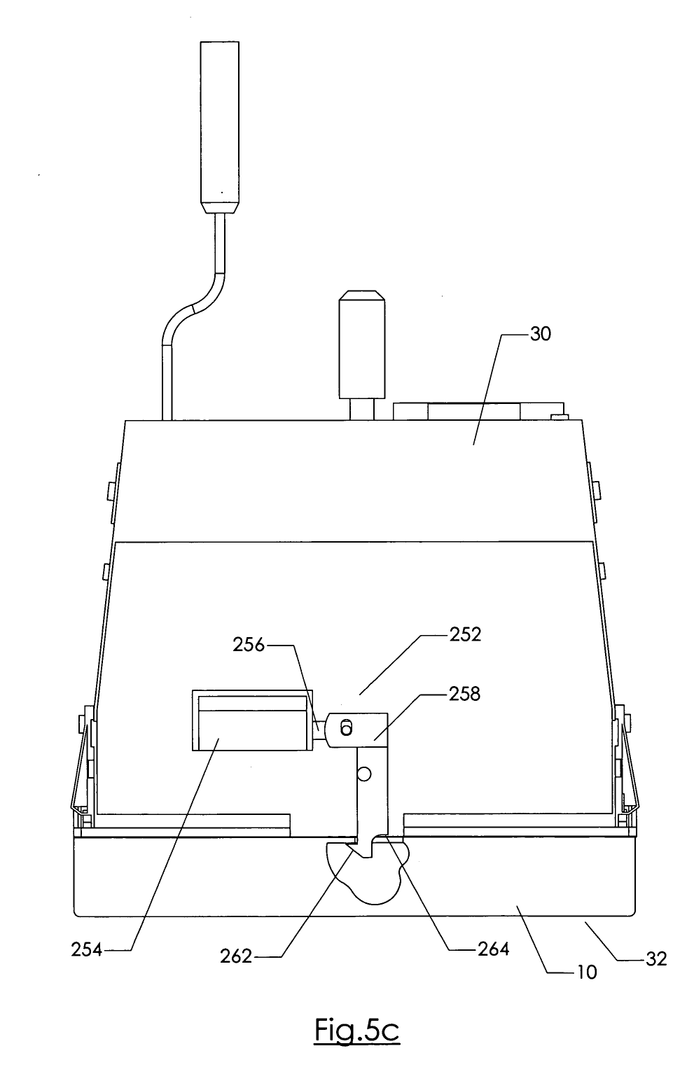

As shown in FIGS. 2-4A, 4B, 5A, and 5B, a front panel 32 is pivotally coupled to the central unit 30 for movement between a closed position (shown in FIGS. 4A and 4B) and an opened position (shown in FIGS. 5A and 5B). During normal operation of the data acquisition and display system 10, the front panel 32 is maintained in the closed position. However, as explained in greater detail below, operators can move the front panel 32 toward the opened position to perform maintenance on the data acquisition and display system 10 and/or to install components in or remove components from the central unit 30.

To move the front panel 32 from the closed position to the opened position, an operator depresses one or more buttons located on the front panel 32 to release a first latching mechanism (shown in FIG. 5C). Alternately, a solenoid, which holds the front panel 32 in place, is deactivated by an operator's selection of menu items within the operating environment. A biasing mechanism (not shown), then moves the front panel 32 toward the opened position. To move the front panel 32 from the opened position to the closed position, the operator grasps the front panel 32 and pivots the front panel 32 toward the central unit 30 until the latching mechanism secures the front panel 32 in the closed position.

In some constructions (not shown), the latching mechanism includes a lock (e.g., a mechanical locking mechanism, an electronic lock, etc.). In these constructions, only authorized operators having the correct key or key code can move the front panel 32 from the closed position to the opened position.

The front panel 32 includes a monitor or video display screen 36 and a user interface or control pad 40. In the illustrated construction, the video display screen 36 is a 3.8 inch flat color TFT liquid crystal (“LCD”) display screen. However, in other constructions (not shown), other conventional display screens can be used, such as black and white screens, picture tube screens, and high definition screens. The user interface 40 includes a number of buttons, knobs, and dials for controlling operation of the data acquisition and display system 10. In some constructions, at least a portion of the user interface 40 includes soft rubber buttons and back lighting to facilitate operation of the data acquisition and display system 10 at night or in other low lighting environments.

More particularly, in the illustrated construction (see FIGS. 2 and 4A), the user interface 40 includes a number of buttons for controlling operation of the video cameras (described below) and operating the video playback function (described below), including a “MARK” button, three record buttons (“REC 1”, “REC 2”, and “REC 3”), a “STOP” button, a rewind or “REW” button, a “PLAY” button, a fast forward or “FF” button, and a “PAUSE” button. The user interface 40 also includes a number of radio control buttons, including a “SEEK” button (with up and down arrows), an “AM” button, an “FM” button, a “RADIO” power button, a radio “VOLUME” control button (with up and down arrows), and preset radio station buttons “1”, “2”, and “3”. In addition, the user interface 40 includes a number of system control buttons, including a system “POWER” button, a camera zoom in or “Z-IN” button, a camera zoom out or “Z-OUT” button, an “AUTO” button, display screen adjustment buttons “MON” (for adjusting the screen brightness) and “PLN” (for adjusting back lighting of the user interface 40), microphone volume buttons (labeled “VOL EXT” and “VOL INT”), an “ENTER” button, a “MENU” button, a “MON” button for selecting screen display options, an “INT MIC” button for activating the internal microphone, and a camera toggle button (labeled “CAM”). Additionally, in some constructions, the REC 1 button includes the letters “ABC”, the REC 2 button includes the letters “DEF”, the REC 3 button includes the letters “GHI”, the REW button includes the letters “JKL”, the PLAY button includes the letters “MNO”, the FF button includes the letters “PRS”, the PAUSE button includes the letters “TUV”, the AUTO button includes the letters “WXY”, the Z-IN button includes the letters “QZ”, and the Z OUT button includes the word “SPACE”. In constructions having letter buttons, the letter buttons can be used to enter text messages into and/or upload data onto the data acquisition and display system 10. The user interface 40 also includes a number of indicator lights 41, which indicate, for example, when the system power is on or off, when the radio is on or off, and which camera is transmitting video data to the recording media 44. The functions of the various buttons and indicator lights 41 are explained in greater detail below.

The vehicle engine 42 and/or the vehicle battery 43 provide power to the data acquisition and display system 10. Additionally, as shown in FIGS. 4B and 5B, the central unit 30 houses an internal power supply 45 (e.g., a battery, a fuel cell, etc.), which provides backup power to the data acquisition and display system 10 to maintain memory of the data acquisition and display system 10 if the power supply from the vehicle engine 42 and/or the vehicle battery 43 is interrupted.

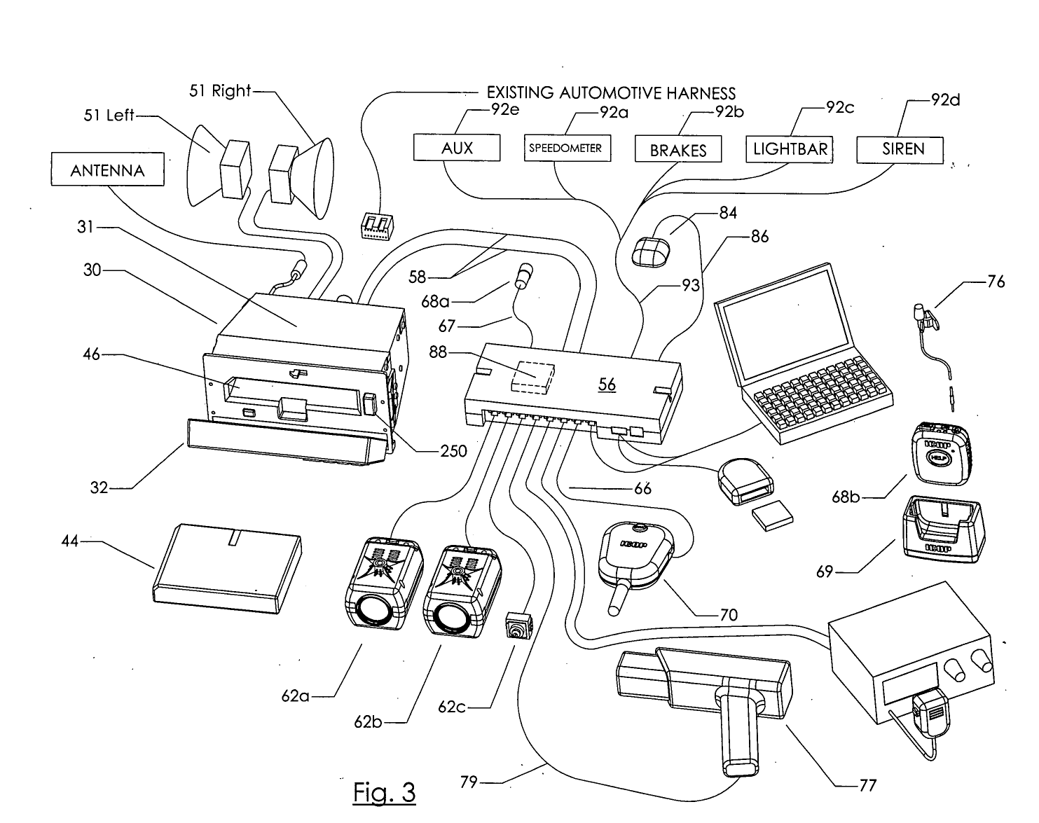

As shown in FIGS. 3, 4B, 5A, and 5B, the central unit 30 also houses recording media 44 (e.g., a digital memory unit) in a drive slot 46. Recording media 44 includes any number of devices that enable fast random access to digitally recorded data. The recording media 44 is mechanically guided and engaged to an electrical connector in the central unit 30 by a second latching mechanism 49 and is protected from theft and/or damage by the front panel 32. To remove the recording media 44 from the central unit 30, an operator moves the front panel 32 toward the opened position and depresses an “EJECT” button 250 (see FIG. 5A). In this manner, the operator can remove and/or replace the recording media 44 as needed. Additionally, the recording media 44 can be removed from the central unit 30 and can be moved to a remote location to facilitate the downloading or uploading of data. For example and as explained in greater detail below, after an arrest or at the end of a shift, an operator can remove the recording media 44 from the central unit 30 and bring the recording media 44 to a police station or headquarters building where data can be downloaded to or saved onto a central computer 94 (shown in FIG. 10) or computer network.

In addition, in some constructions, the locking mechanism (described above) limits access to the recording media 44 so that only a limited number of operators can access the recording media 44. In this manner, the evidentiary quality of data stored on the recording media 44 can be preserved and data tampering can be prevented. For example, the locking mechanism can be locked so that patrol officers cannot open the front panel 32 and only supervisory level officers (e.g., sergeants, lieutenants, captains, etc.) can gain access to the recording media 44.

The central unit 30 also houses a heating unit 48 (see FIGS. 4B and 5B) located in the drive slot 46. The heating unit 48 is in communication with the controller 31 and temperature sensors (not shown). When the temperature sensors record a temperature below a predetermined value (e.g., 50° F.), the controller 31 activates the heater 48 to maintain the temperature of the controller 31 and the recording media 44 above the predetermined value and to maintain effective operation of the controller 31 and the recording media 44.

The central unit 30 also houses a clock 47 (see FIGS. 4B, and 5B), which is programmed to display the time and/or date on the display screen 36. Also, as described below, the clock 47 is in communication with the controller 31 and the recording media 44. In this manner, the controller 31 and the recording media 44 can coordinate or index time and date data with other recorded data, such as, for example, vehicle status data, vehicle location data, vehicle speed data, video data, and sound data.

As shown in FIG. 2, in some constructions, the central unit 30 also houses a conventional in-car entertainment system such as a CD player, cassette player or AM/FM band radio 50. It should be understood that reference to radio 50 in the subsequent descriptions is merely for illustrative purposes only and such reference is equally applicable to other entertainment systems. In these constructions, the AM/FM radio 50 is in communication with the antenna 16 and the vehicle speaker system (not shown). Moreover, as mentioned above, in some applications, installation of the central unit 30 in 25 the aperture 26 in the console 22 requires the removal of the vehicle's manufacturer installed AM/FM radio. In these applications, the AM/FM band radio 50 replaces the vehicle's manufacturer-installed radio and provides the passengers with audio entertainment and/or news and weather information. Even further, the manufacturer provided radio antenna connector and the main AM/FM connector for power and the vehicle speakers are utilized to provide connectivity to the display system 10. Operation of the radio 50 is controlled in a conventional manner using the RADIO power button to activate the radio, the AM button to select the AM band, the FM button to select the FM band, the radio VOLUME control button to adjust the radio volume, and preset radio buttons 1, 2, and 3 to store and recall radio stations. As previously discussed, in other constructions (not shown), the radio 50 includes a CD player, a cassette player, and a satellite radio.

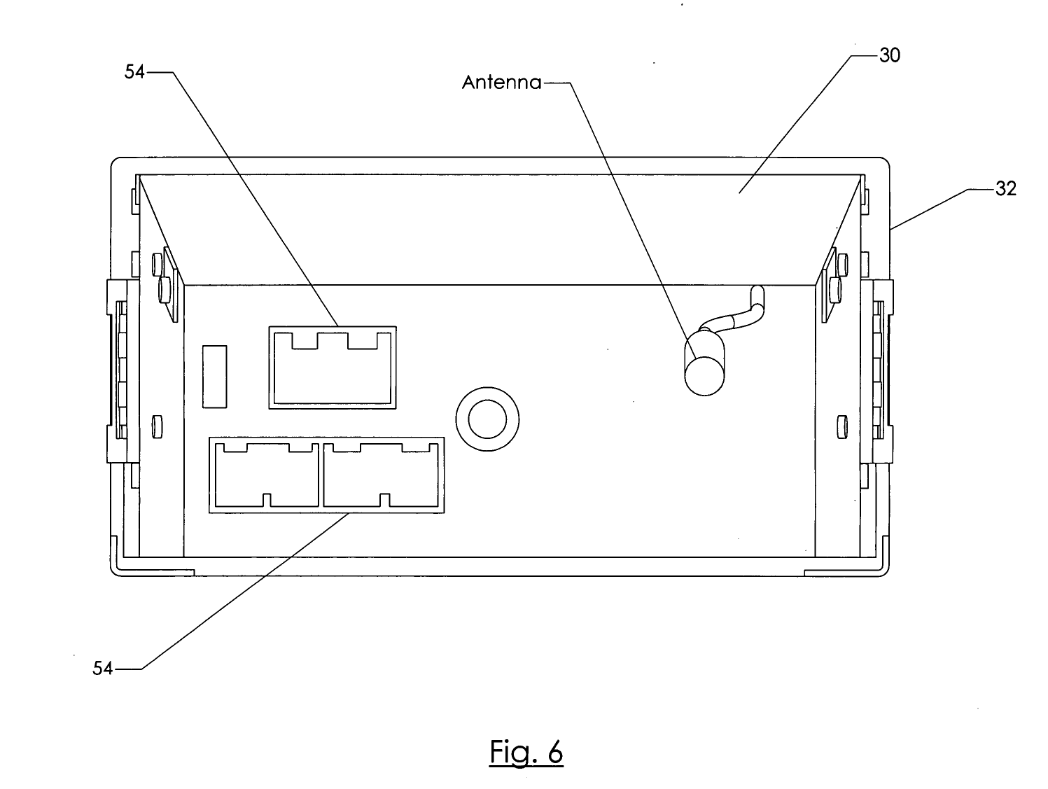

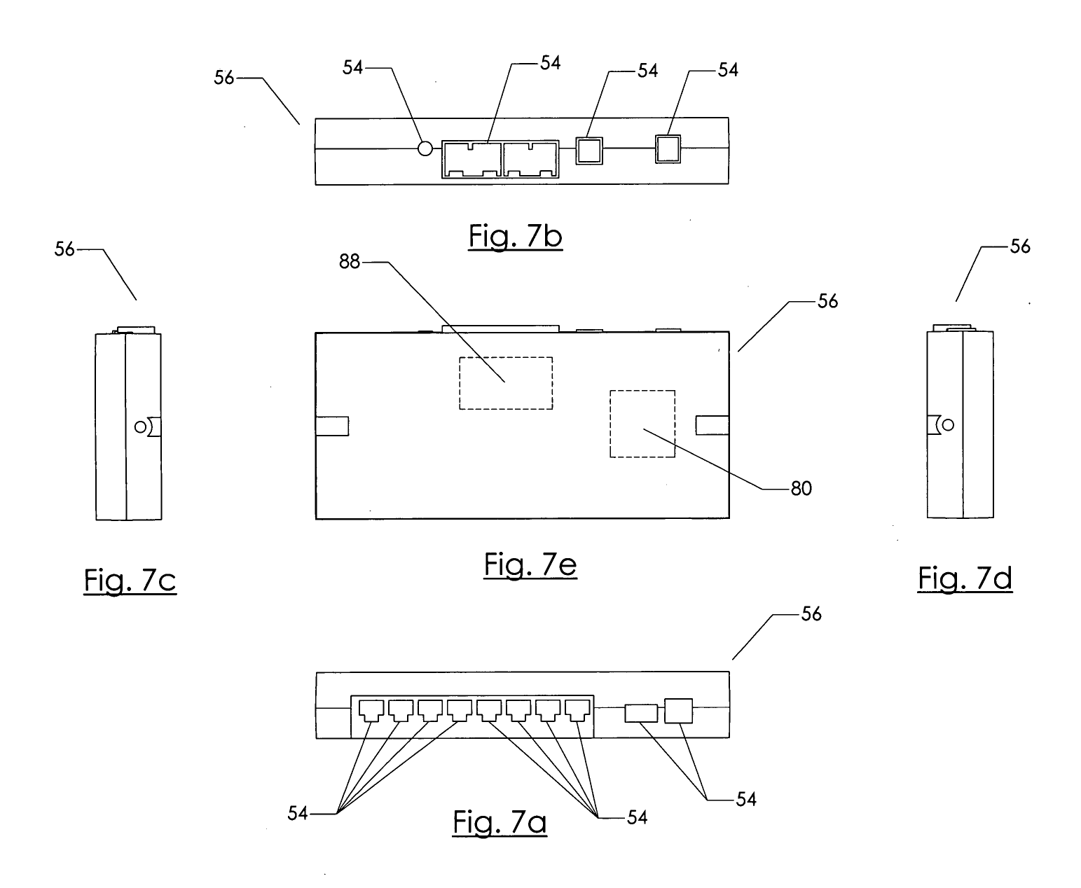

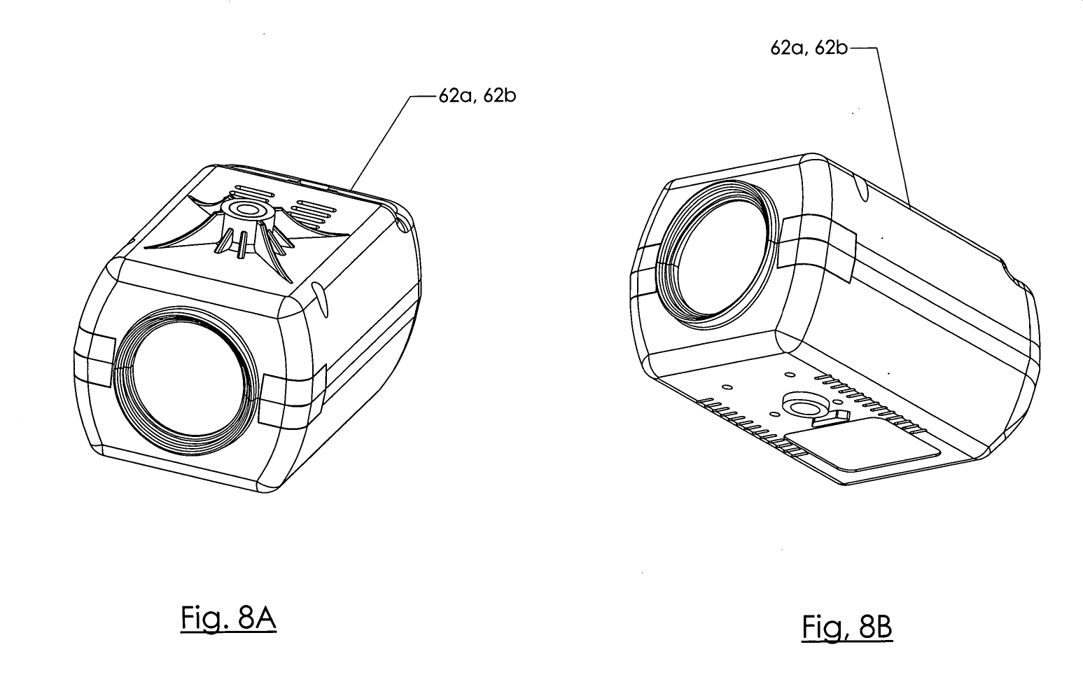

As shown in FIG. 6, the central unit 30 also includes a number of communication connections, ports or jacks 54 such as, for example, USB ports, coaxial cable ports, phone jacks, RCA cable ports, etc. As shown schematically in FIG. 3, a line 58 extends between one of the communication ports 54 and a junction box 56, which also includes a number of communication ports 54. As shown in FIGS. 7A-7E, the junction box 56 also includes nonphysical-connection-based communication ports 55a, such as, for example, infrared, wireless and microwave receiving ports. In the illustrated construction, the junction box 56 is attached to the dashboard and is located under the instrument console 22. In other constructions (not shown), the junction box 56 can be located in the vehicle trunk, under the driver seat 20, in a second aperture (not shown) in the instrument console 22, or in another suitable location in the vehicle V.

The data acquisition and display system 10 also includes a number of cameras 62 located throughout the vehicle V. Cameras 62 can be video or audio/video devices, which may be wired or wireless. In the illustrated construction, a first camera 62a (shown in FIGS. 1-3) is positioned above the instrument console 22 and adjacent to the vehicle's rearview mirror 64. The first camera 62a is directed forwardly to record activity in front of the vehicle V, such as, for example, the actions of a suspect vehicle during a police pursuit or a traffic stop. A second camera 62b (shown in FIGS. 1 and 3) is located within the interior section of the vehicle on the ceiling and is directed rearwardly in the vehicle to record activity behind the vehicle V, such as, for example, suspect arrests, searches of suspects and suspect vehicles, and traffic stops. A third camera 62c (shown in FIGS. 1 and 3) is located on the vehicle ceiling and is directed rearwardly toward the backseat to record the activity of passengers in the backseat. As would be understood, the various cameras 62 can be attached to numerous other locations without departing from the scope of the present invention.

In the illustrated construction, the first and second cameras 62a and 62b are analog/digital video cameras capable of recording color images and the third camera 62c is an analog/digital video camera capable of recording infrared images. However, in other constructions, the present invention can also include still cameras and black and white cameras, and low ambient-light (i.e., night-vision) cameras. Additionally, while the illustrated construction includes three cameras 62, in other constructions (not shown), the present invention can include one, two, four, or more cameras. For example, in some constructions, cameras 62 are mounted on the vehicle ceiling and are directed toward the side windows to record activity on the right and left sides of the vehicle V. In still other constructions (not shown), one or more of the cameras 62 are remotely positionable so that the operator can adjust the direction of the cameras 62 to record activity in front of the vehicle V, to the left of the vehicle V, to the right of the vehicle V, behind the vehicle V, or inside the vehicle V.

In an embodiment of the present invention, a rearward facing camera can have a mirror option applied to its received data so as to cause viewed objects to be displayed as they would normally be observed through a rear view mirror.

In a further embodiment, dual channel recording is provided by the present invention. For example, camera #1 may have its information separately stored on one channel while cameras #2 and #3 are stored on a separate channel.

Data recorded by the cameras 62 is transmitted across lines 66 (illustrated schematically in FIG. 3) back to the junction box 56 and along line 58 from the junction box 56 to the controller 31 and the recording media 44 where the data is stored and indexed for later retrieval. Also, as explained below, video data from the cameras 62 is indexed and coordinated with other recorded data, such as, for example, date and time data, vehicle status data, vehicle velocity data, vehicle location data, and sound data. In this manner, when the recorded video data is replayed, it is possible to determine when the video data was recorded, where the video data was recorded, the status of the vehicle V during video recording, the location of the vehicle V during video recording, and whether there was any verbal communication or other background sound during video recording. All of this data can be useful for evidentiary purposes and for investigative purposes. More particularly, this data can be used during a court hearing to prosecute a suspect and/or to investigate allegations of inappropriate behavior by police officers. Additionally, because officers and suspects are likely aware of the presence of the cameras 62, many suspects and many officers will avoid inappropriate behavior.

In an alternate construction, the data acquisition and display system 10 can include a remote handheld video camera (not shown) which can be carried by an operator to record video data when he leaves the vehicle V to chase a suspect or to investigate a building or another vehicle. When the operator returns to the vehicle V, the operator can upload recorded video data from the handheld camera to the controller 31 and the recording media 44 via one of the communication ports 54 for indexing and storage in the recording media 44. Alternatively, the camera could wirelessly communicate video data to the controller 31 or the data acquisition and display system 10, in real-time or upon the conclusion of the recording session, alternatively the camera could communicate with an extension cable back to communication port 54.

In some constructions, the recording media 44 records video data on a single channel. In these constructions, the controller 31 is programmed to record video data from one camera 62 (e.g., the first camera 62a) during normal operation. The operator can then select an alternate camera 62 (e.g., the second or third camera 62b, 62c) with the “CAM” button or the REC 1, REC 2, or REC 3 buttons as desired (e.g., when a passenger is in the backseat). In other constructions, the recording media 44 records two channels of video data simultaneously. In these constructions, the controller 31 is programmed to record video data on two channels from two cameras 62 (e.g., the first and second cameras 62a, 62b) during normal operation. The operator can then select an alternate camera configuration (e.g., the first camera 62a and the third camera 62c) as desired (e.g., when a passenger is in the backseat).

During normal operation and as mentioned above, the first camera 62a is directed forwardly and is focused to record activity occurring in a broad area in front of the vehicle V, the second camera 62b is directed rearwardly and is focused to record activity occurring in a broad area behind the vehicle V, and the third camera 62c is directed rearwardly and is focused to record activity within the vehicle such as in the backseat. Additionally, in some constructions, an operator can remotely adjust the orientation of the first, second, and third cameras 62a, 62b, and 62c to pan to the right, left, above, or below the predetermined focal points. The operator can also adjust the focal point of the first, second, and third cameras 62a, 62b, 62c and can zoom in or zoom out using the “Z-IN” and “Z-OUT” buttons. In a further embodiment of the present invention, the cameras 62a and 62b may be placed in a macro mode, i.e. a mode for close-up viewing/capture of objects such as a driver's license.

Video data from the video camera 62 can also be displayed on the display screen 36 in real time so than an operator can discreetly monitor activity outside the vehicle V and/or activity of a passenger in the backseat. Alternatively, previously recorded video data can be played back on the display screen 36. In constructions of the data acquisition and display system 10 having multiple video cameras 62, the operator can toggle between the video cameras 62a, 62b, and 62c using the “CAM” button to display data from any one of the video cameras 62a, 62b, and 62c on the display screen 36. Also, in constructions of the present invention in which video data from two cameras is simultaneously recorded, the operator can review previously recorded video data on the display screen 36 from either of the video channels by toggling between the two channels using the “CAM” button.

The data acquisition and display unit 10 also includes audio recording apparatus or microphones 68. A first or internal microphone 68a (see FIG. 3) is positioned inside vehicle V to optimally (not shown) record a passenger's voice. Sound data recorded by the first microphone 68a is transmitted across a communications line 67 (shown schematically in FIG. 3) back to the junction box 56 and along line 58 from the junction box 56 to the controller 31 and the recording media 44 where the sound data is stored and indexed for later retrieval. As previously described with respect to the communication of video data, audio data can be transmitted as described, or wirelessly, and directly or indirectly provided for recording on recording media 44. Also, as explained below, sound data from the first microphone 68a is indexed and coordinated with other recorded data, such as, for example, date and time data, vehicle status data, vehicle speed data, vehicle location data, and video data. In this manner, when the recorded sound data is replayed, it is possible to determine when the sound data was recorded, where the sound data was recorded, the status of the vehicle V during recording, and the location of the vehicle V during recording. To prevent feedback and to obtain the best possible sound data, the controller 31 is programmed to deactivate the vehicle speakers when the first microphone 68a is recording.

In some constructions, the data acquisition and display system 10 includes a second cordless or external microphone 68b (e.g., a walky-talky, a two-way radio, etc.). In these constructions, the microphone 68b transmits sound data in a known manner to one of the nonphysical-connection-based in-car transceiver #70 connected to communication port 54a on the junction box 56. Additionally, in these constructions, the operator can bring the second microphone 68b with him when he leaves the vehicle V to approach a suspect or to investigate a building or a parked vehicle or the like.

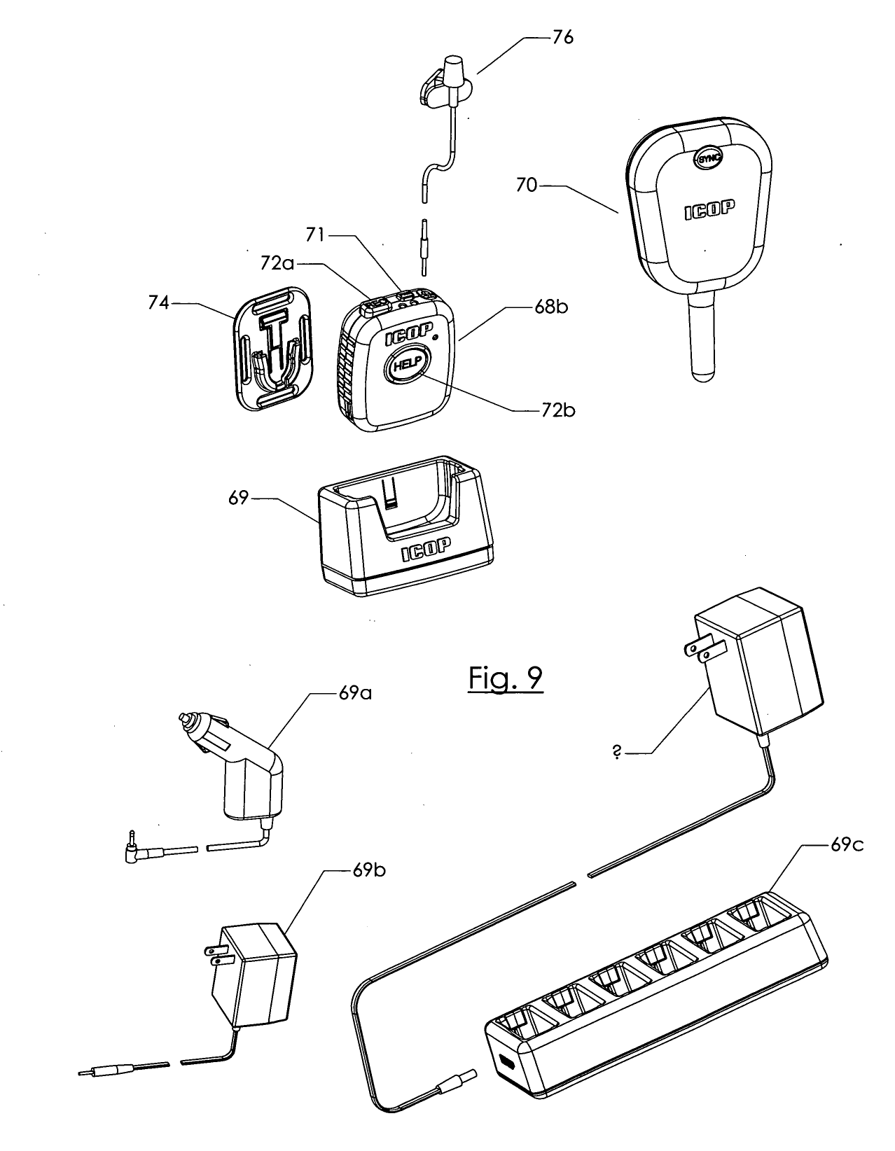

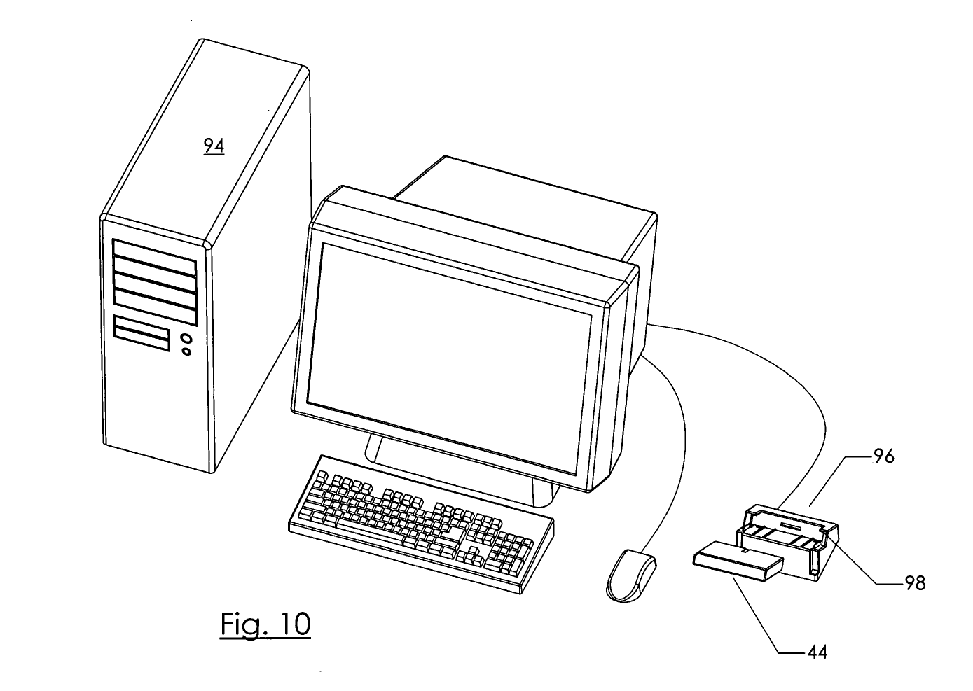

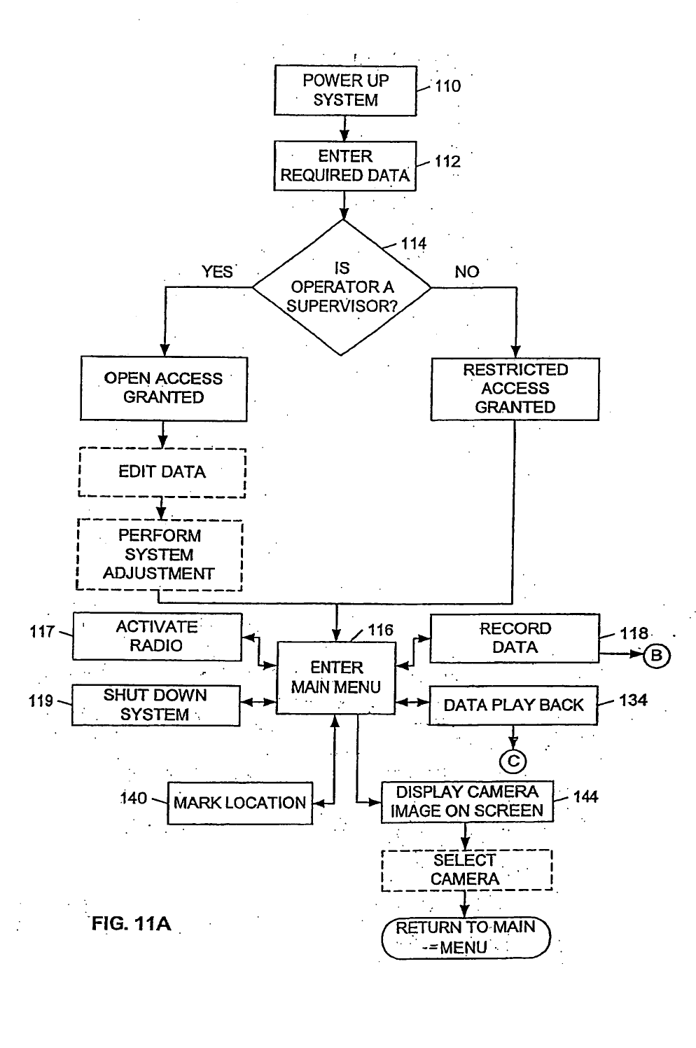

As shown in FIG. 9, in some constructions, the second microphone 68b includes a charging station 69. The charging station 69 can be mounted in the vehicle V, or alternately, other charging devices 69a, 69b, and 69c can be located in a headquarters building, home or vehicle V. The second microphone 68b can be placed in the charging station 69 to recharge the mobile unit's internal battery (nickel metal hydride (NiMH) battery.

The second microphone 68b includes two LED's that display battery condition, synchronization and communication indications, a “RECORD” button 72a, and a “HELP” button 72b, and a power ‘ON’/‘OFF’ button 71. A LED indicator (flashes yellow) to alert the operator whether the second microphone 68b is within range or out of range of the controller 31 and to indicate whether or not a communication line can be established between the second microphone 68b and the controller 31.

In the construction illustrated in FIG. 9, the second microphone 68b also includes a belt clip 74 and a corded microphone 76. During operation, the operator can clip the belt clip 74 on his belt and can clip the optional corded microphone 76 to his collar or lapel for convenient handsfree operation.

To communicate, the operator depresses the RECORD 72a button and speaks into the second microphone 68b in a conventional manner. Sound data from the second microphone 68b is transmitted across one of 1040 channels in the 900 MHz range (e.g., between about 902 MHz and about 928 MHz) back to the in-car transceiver #70, connected to communication port 54a on the junction box 56 and along line 58 from the junction box 56 to the controller 31 and the recording media 44 where the sound data is stored and indexed for later retrieval or transmitted to some other device. Also, as explained below, sound data from the second microphone 68b is indexed and coordinated with other recorded data, such as, for example, date and time data, vehicle status data, vehicle location data, vehicle speed data, and video data. In this manner, when the recorded sound data is replayed, it is possible to determine when the sound data was recorded, where the sound data was recorded, the status of the vehicle V during recording, and the location of the vehicle V during recording.

In addition to recording the sound data from the second microphone 68b, the controller 31 also transmits the sound data to the intended recipient (e.g., other officers, a headquarters building, or a dispatcher), or alternately, broadcasts the sound data to another operator in the vehicle V using the vehicle speakers. The second microphone 68b can also receive sound data from other sources (e.g., from a headquarters, a dispatcher, another officer, or the internal microphone 68a, etc.) in a conventional manner. In addition, in some constructions, sound data from other sources is recorded on the controller 31 and the recording media 44 and is indexed and coordinated with other recorded data for later retrieval.

If the operator is injured and/or unable to speak, the operator depresses the HELP button 72b to send a distress signal to the IN-CAR TRANSCEIVER #70 TO THE controller 31 and the recording media 44. When the HELP button 72b is depressed, a signal is sent from the second microphone 68b to the controller 31 and the recording media 44 via communication line 58 and the junction box 56 or otherwise. The controller 31 and the recording media 44 then record the distress call and coordinate and index the distress call with other recorded data, including time and date data, vehicle location data, vehicle status data, vehicle speed data, and video data for later retrieval. The controller 31 also sends a distress signal to a second location (e.g., a headquarters, a dispatcher, etc.). The distress signal is voiced with a synthesized voice chip with location data corresponding to the location of the vehicle V and identification data including the operator's identification or badge number and the vehicle number. Additionally, in some constructions, the controller 31 displays an alert message on the display screen 36 and/or activates an alarm (not shown) in the vehicle V to alert vehicle occupants that the operator is in distress.

As shown in FIG. 1, a speed measuring apparatus 77 (e.g., a radar-based gun or a laser-based speed gun) is mounted on a support bracket 78 on the driver side door alternately radar/laser based speed devices can be mounted inside the vehicle V and is operable to record the speed of target vehicles in a known manner. Speed data recorded by the speed measuring apparatus 77 is transmitted via line 79 or otherwise (shown schematically in FIG. 3) to the controller 31 and the recording media 44. Speed data from the speed measuring apparatus 77 is then stored on the recording media 44. Additionally, the controller 31 coordinates and indexes the speed data with other recorded data, such as, for example, date and time data, vehicle status data, vehicle location data, sound data, and video data. In this manner, the recording media 44 can be searched for speed data given other recorded data, such as, for example, date and time data, and vehicle location data.

In some constructions of the present invention, the controller 31 is programmed to record all speed data recorded by the speed measuring apparatus 77 on the recording media 44. In other constructions, the controller 31 is programmed to record only designated speed data on the recording media 44 to conserve memory space. For example, when an operator is using the speed measuring apparatus 77 to monitor traffic speeds, the operator can designate which speed data is recorded by pressing a record button on the central unit 30 to record a specific speed measurement. In this manner, the operator can selectively record speed data relating to, for example, speed limit violators only. In these constructions, when the operator selects data to be recorded, the speed data displayed on the speed measuring apparatus 77 is transmitted across line 79 to the controller 31 and the recording media 44 and is then coordinated and indexed with other recorded data.

The data acquisition and display system 10 also includes a global positioning system (GPS) 80. In the illustrated construction, the global positioning system 80 includes a GPS antenna 84 housed in the vehicle's top of dash or rear deck (must be able to see vertically through front or rear windshield glass) (see FIG. 1). However, in other constructions (not shown), the GPS antenna 84 can alternately be housed in the vehicle's trunk, under the driver's seat, or in any other location on the vehicle V. The GPS antenna 84 receives location data from earth-orbiting satellites in a conventional manner and transmits the location data across communication line 86 (shown schematically in FIG. 3) or otherwise to a GPS engine 88. In the illustrated constructions, the GPS engine 88 is housed in the junction box 56 and is in communication with the controller 31 and the recording media 44 via communication line 58.

The GPS engine 88 receives location data from the GPS antenna 84 and continually calculates the location of the vehicle V. The GPS engine 88 then transmits vehicle location data across line 58 or otherwise to the controller 31 and the recording media 44 for storage on the recording media 44. Additionally, the controller 31 and the recording media 44 coordinate and index the location data with other recorded data, such as, for example, date and time data, vehicle status data, sound data, vehicle speed data, and video data. In this manner, the recording media 44 can be searched for vehicle location data given other recorded data, such as, for example, date and time data. In some constructions, the global positioning system 80 calculates the location data in the form of latitude and longitude coordinates. In other constructions, the controller 31 sends or receives GPS latitude and longitude across line 58 to junction box 56 to a computer controller with mapping data embedded or DVD that is viewable on display system 10 or on P.C. laptop computer in vehicle V.

The data acquisition and display system 10 also includes a mark and search feature, which allows the operator to identify a given location, based on GPS coordinates, and to recall that location later, or alternatively, to provide the location data to other personnel (e.g., to a police dispatcher or to the occupants of a second vehicle). This feature is particularly useful during pursuit and surveillance activities. For example, when a police car is pursuing a target vehicle and the occupant(s) of the target vehicle jettisons an item (e.g., evidence, a weapon, contraband, etc.), the operator can record the approximate GPS location of the item so that after the pursuit, the operator or other personnel can identify and return to the designated location to search for the item.

To mark a location, the operator depresses the MARK button located on the front panel 32 of the central unit 30. The controller 31 and the recording media 44 then save the location data generated by the global positioning system 80 at the time that the MARK button was depressed. More specifically, a notation is embedded into the recording to identify the previous 200 frames and related GPS coordinate information. The designated location data is then displayed on the display screen 36 to confirm to the operator that the data display and acquisition system 10 has recorded the location data. Other recordings such as audio or video are also associated and related to the instance of the Mark thus allowing such recordings to be later identified and located in conjunction with the Mark.

The system and method of the present invention essentially provides for the recording of searchable parameters in addition to audio and/or video data. A relationship between video, audio and search parameters is established utilizing some synchronous measure such as time. It would be understood by those skilled in the art that a wide variety of parameters may be captured and utilized as searchable items.

The data acquisition system 10 includes a number of vehicle sensors 92 distributed throughout the vehicle V. In the illustrated construction, a first sensor 92a (shown in FIGS. 1 and 3) is positioned in the dashboard and receives vehicle speed data from the vehicle speedometer. A second sensor 92b (shown in FIGS. 1 and 3) is connected to the vehicle brakes and records breaking conditions (i.e., that brakes have been activated or that brakes are inactive). A third sensor 92c (shown in FIGS. 1 and 3) is positioned to communicate with the light bar 12 to record whether or not the lights have been activated. A fourth sensor 92d (shown in FIGS. 1 and 3) is positioned to communicate with the siren 14 to record whether or not the siren 14 has been activated; a fifth sensor 92e (shown in FIG. 3) is an auxiliary (“AUX”) trigger. The vehicle status sensors 92 record vehicle status data and transmit the vehicle status data across communication lines 93 or otherwise (shown schematically in FIG. 3) to the controller 31 and the recording media 44 via the junction box 56 and communication line 58. The controller 31 and the recording media 44 then record the vehicle status data and index and coordinate the vehicle status data with other recorded data, including date and time data, video data, vehicle location data, and sound data.

To download data from the data acquisition and display system 10, or alternately, to upload data onto the data acquisition and display system 10, the recording media 44 is removed from the control unit 30 and the recorded information is conveyed to a central storage unit 94 (e.g., a computer, a computer network terminal, etc). Understandably, such data transfer may be performed without the physical transportation of the media 44. As described above, in some constructions, a locking mechanism limits access to the recording media 44 and prevents unauthorized people from opening the front panel 32. Therefore, in constructions having a locking mechanism, an operator enters the key code using the user interface 40, or alternately, inserts a mechanical key into a corresponding aperture (not shown) on the front panel 32. The operator then moves the front panel 32 toward the opened position and depresses the EJECT button to remove the recording media 44 from slot 46 in the central unit 30. The operator then inserts the recording media 44 into a drive 96 (shown in FIG. 10), which includes a slot 98 configured to receive the recording media 44. Data can then be uploaded from the recording media 44 to the central storage unit 94, or alternately, from the central storage unit 94 to the recording media 44 in a conventional manner. A separate set of application programs, located on the central storage unit 94, provide access to such data and include features to effectively search, locate and present the data for human or other system interaction. After downloading and/or uploading is complete, the recording media 44 can be cleared to provide additional storage space for new data.

Data downloaded from the recording media 44 onto the central storage unit 94 is further indexed and stored for later retrieval. In some applications, the data is stored indefinitely. In other applications, the data is stored for a prescribed period of time (e.g., 3 months, 1 year, 5 years, etc.) and is then automatically deleted from the central storage memory to provide storage capacity for new data.

In applications of the present invention in which the recording media 44 is a digital memory unit, each frame of video data is sequentially numbered. In this manner, video data cannot be altered or deleted from the recording media 44 or the central storage unit 94 without some indication that the recorded video data has been altered.

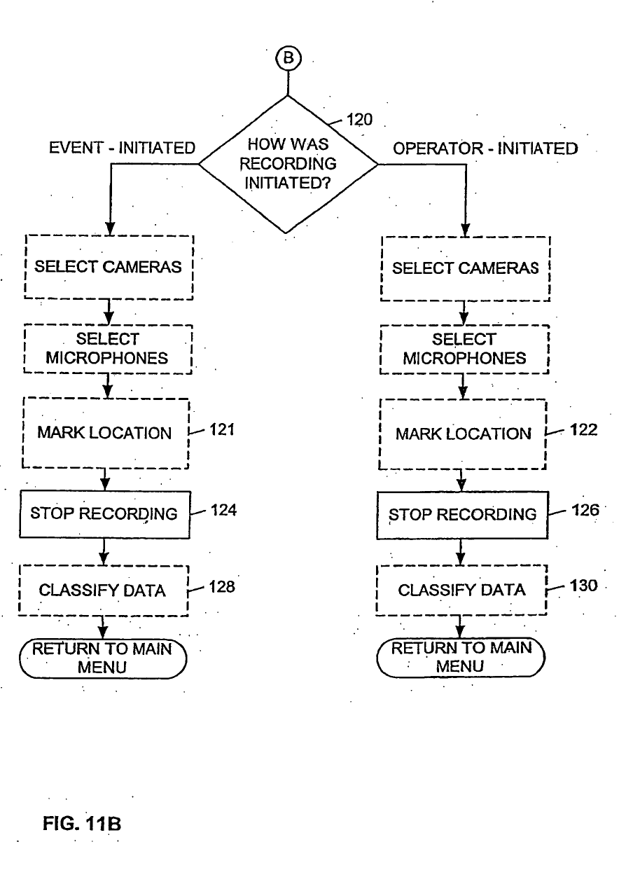

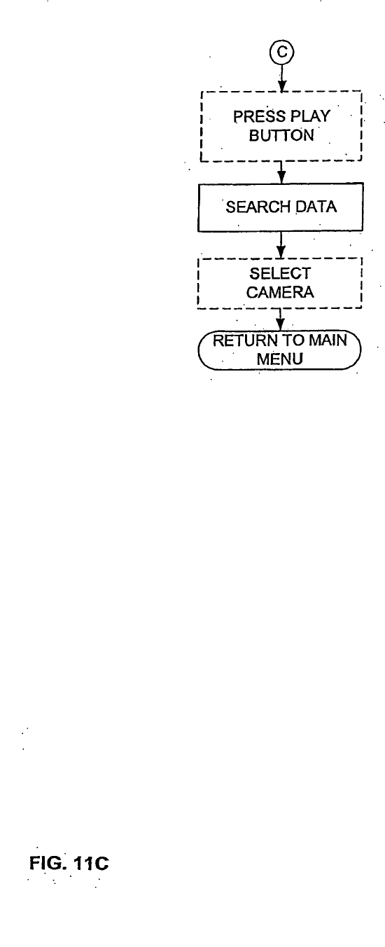

FIGS. 11A-11C illustrates a method of operating the data acquisition and display system 10 according to the present invention. In a first act 110, the data acquisition and display system 10 is activated when an operator depresses the POWER button. In some constructions, the data acquisition and display system 10 remains operational at all times and is only powered down during service and maintenance procedures. In other constructions, the data acquisition and display system 10 is powered down every time an operator completes his shift and returns the vehicle V to headquarters.

In act 112, the display screen 36 displays a data entry screen and the operator is prompted to input data (e.g., the operator's name, the operator's badge number, the vehicle identification number, a password, the operator's rank, etc.). Once the operator enters the required information, the controller 31 determines the operator's level of authority based upon the data input in act 114. If the operator is a supervisor (“YES” at act 114), the operator is granted open access to the data acquisition and display system 10 and the operator is allowed to edit configuration data, and change settings and defaults or perform other system adjustments. If the operator is not a supervisor (“NO” at act 114), the operator is granted limited access.

In act 116, the display screen 36 displays a main menu. From the main menu, the operator can perform a number of functions such as activate the radio 50, shut down the data acquisition and display system 10, play previously recorded video data on the display screen 36, display video data on the display screen 36 in real time, record data, or mark a geographic location. In other words, the operator is able to navigate through the system and utilize authorization functions. To activate the radio 50, the operator presses the RADIO button in act 117 and operates the radio 50 in a known manner. To shut down the data acquisition and display system 10, the operator presses the POWER button in act 119 and the data acquisition and display system 10 shuts down. However, in some constructions, operators, and particularly operators having restricted access, are prevented from shutting down the data acquisition and display system 10.

With reference to act 118, data recording can be initiated in either of two manners. First, in act 120 (see FIG. 111B), by selecting “OPERATOR-INITIATED” on the main menu, the operator can record video data from one of the cameras 62a, 62b, 62c, or alternatively, in constructions having two video channels, the operator can record video data from any two combinations of the cameras 62a, 62b, and 62c. Additionally, during OPERATOR-INITIATED recording, the operator can direct the controller 31 and the recording media 44 to record data from one or more of the first and second microphones 68a, 68b, the GPS engine 88, the clock 47, the speed measuring apparatus 77, and the vehicle sensors 92a, 92b, 92c, 92d. The recorded data is then transmitted to the controller 31 and the recording media 44 where the data is indexed and relatedly coordinated as described above for later retrieval.

Alternatively, “EVENT” recording can be initiated automatically in act 120 when any one of a number of events occurs. For example, in some constructions, EVENT recording is initiated when the operator activates the siren 14 and/or the light bar 12, and/or AUX input. Alternatively, EVENT recording can be initiated when the speed measuring apparatus 77 records speed data above a predetermined value (e.g., above 80 mph) and/or when the CALL button is depressed. During EVENT recording, the controller 31 and the recording media 44 automatically record data from two predetermined cameras 62 (e.g., the first and second cameras 62a, 62b), the first and second microphones 68a, 68b, the GPS engine 88, the clock 47, the speed measuring apparatus 77, and the vehicle sensors 92a, 92b, 92c, 92d, and 92e. The recorded data is also indexed and relatedly coordinated as described above for later retrieval.

Once recording, of either OPERATOR-INITIATED or EVENT, is initiated the operator can alter the camera configuration so that, for example, the controller 31 and the recording media 44 record video data from the first and third cameras 62a, 62c. Also, the operator can deactivate and reactivate either of the microphones 68a, 68b. Additionally, after recording is initiated, the operator can mark a geographic location in acts 121, 122.

To ensure that the controller 31 and the recording media 44 record as much relevant data as possible, in some constructions, the data acquisition and display system 10 is programmed to continuously record video data, sound data, time and date data, vehicle status data, and vehicle location data for a predetermined time (up to 1 minute) and then to record over the previously recorded data. In these constructions, the recording media 44 continuously records data and then records over that data until OPERATOR-INITIATED or EVENT recording is initiated and once OPERATOR-INITIATED or EVENT recording is initiated, the recording media 44 saves the previously recorded data (up to 1 minute of data) and all data collected after OPERATOR-INITIATED or EVENT recording is initiated until the operator presses STOP in act 124 or act 126. In this manner, the recording media 44 also stores data from a relatively short period before OPERATOR-INITIATED or EVENT recording is initiated and stores data collected after OPERATOR-INITIATED or EVENT recording is initiated. The data recorded before OPERATOR-INITIATED or EVENT recording is initiated provides context to the data recorded after OPERATOR-INITIATED or EVENT recording is initiated and can be of particular investigative and/or evidentiary value.

After recording is stopped, the operator can classify the recorded data in acts 128, 130. More particularly, in acts 128, 130, the operator can add a classification code to the recorded data so that the recorded data can be indexed and/or categorized by the classification code for later retrieval. The classification codes can be preset during system set up and can be reconfigured as needed. For example, in some constructions, the data display and acquisition system 10 can be programmed to include classification codes (e.g., K000, X1M1, K2F3, etc.) for traffic violations (failure to yield, speeding violations, running a red light, etc.), domestic disturbances, robberies, and weapons related incidents (e.g., armed robbery, concealed weapons violations, etc.), for male/female designation, for race (e.g., White, Black, Hispanic). In these constructions, the operator classifies the recorded data in acts 128, 130 by entering a 4 digit number code (e.g., K2F3) using the EVENT entry screen so that recorded data can later be retrieved according to classification code. Even further, the operator can provide Event Identification codes such as a case or ticket number to be associated with the classification code. A flag can also be set to indicate whether or not to keep the recorded event. It should be noted however that such designation would not cause the event to be erased/removed from the recording media 44.

In operation 128, 130, an Event Identification is provided in the following manner. After recording an event and pushing “stop,” an “Event ID” Screen is displayed to prompt and accept operator input. The operator may then interact with the system and respond to field prompts for values such as “Ticket/Case” number, e.g., 20045325. Another field requesting a “K” or “X” allows the operator to elect to keep or not keep the particular event. Another field is type of an event (traffic stop (routine), traffic stop (felony), traffic accident) or the operator may then select an event type from a predefined list, followed by a gender identifier (M=male or F=female). Next, an identification of race can be made using a previously defined list of options. In the event that an operator fails to provide event identification, default identification is provided by the system. Here also, as with other recorded parameters and data, the event identification is a searchable item. Searchable items may be used by the search engine of the central storage unit 94 or by the data acquisition and display system 10.

As shown in FIG. 11A, the operator can replay or review previously recorded data. To review previously recorded data, the operator selects “DATA PLAYBACK” on the main menu in act 134. The operator can then select video data to replay on the display screen 36 using the PLAY, FF, and REW buttons in a known manner. Additionally, during DATA PLAYBACK, additional recorded data, including vehicle location data, vehicle status data, vehicle speed data, and classification code data corresponding to the video data can also be displayed on the display screen 36 and sound data is broadcast over the vehicle's speakers simultaneously or nearly simultaneously with the corresponding video data. As explained above, in some constructions, the recording media 44 records data from two cameras 62 (e.g., 62a, 62b) simultaneously. In these constructions, operators can review data recorded by either of the two cameras 62 on the display screen 36 and can toggle between data recorded by either of the cameras 62 using the CAM button.

As explained above, the data acquisition and display system 10 includes a mark and search feature, which allows the operator to identify a given location based on GPS coordinates and to recall that location later, or alternatively, to provide the location data to other personnel (e.g., to a police dispatcher or to the occupants of a second vehicle). To mark a location, the operator depresses the MARK button in act 121, 122. The controller 31 and the recording media 44 then save the location data generated by the global positioning system 80 at the time that the MARK button was depressed. The designated location data is then displayed on the display screen 36 to confirm that the data display and acquisition system 10 has recorded the location data.

To display images recorded by the cameras 62 on the display screen 36 in real time, the operator selects “DISPLAY CAMERA IMAGE ON SCREEN” from the main menu in act 144. In this manner, the operator can view data recorded by any one of the cameras 62 (e.g., the first, second, or third cameras 62a, 62b, 62c) in real time and can toggle between the cameras 62 using the CAM button. Therefore, the operator can discretely monitor activity occurring around the vehicle V and/or in the back seat of the vehicle V. As previously described such review, search and tracking functions can be performed at the central storage unit 94.

An alternate construction of a data acquisition and display system 1A is illustrated in FIGS. 12A-12C. Common elements are identified by the same reference number “A”. In the illustrated construction, the vehicle V is a Chevrolet Tahoe.

A central portion of the console 22A defines an aperture 26A. In the construction illustrated in FIGS. 12A-12C, the aperture 26A is a double-din bin and the central unit 30 is sized to be received in the aperture 26A. More particularly, the central unit 30 is sized to be received in the double-din bin of a Chevrolet Tahoe.

The constructions described above and illustrated in the drawings are presented by way of example only and are not intended to limit the concepts and principles of the present invention. As such, it will be appreciated by one having ordinary skill in the art, that various changes in the elements and their configuration and arrangement are possible without departing from the spirit and scope of the present invention as set forth in the claims.

1. A recording apparatus for mounting in a vehicle having an interior console and an aperture in the console, the apparatus comprising:
a frame mountable in the aperture;
a recording media housed in said frame; and
an input device in communication with said recording media to provide one or more input data to said recording media.

2. The recording apparatus of claim 1, wherein said input data is video.

3. The recording apparatus of claim 1, wherein said input data is audio.

4. The recording apparatus of claim 1, wherein said recording media is a digital memory unit.

5. The recording apparatus of claim 1, wherein the aperture includes a double-din.

6. The recording apparatus of claim 1, further comprising an entertainment device housed in said frame.

7. The recording apparatus of claim 6, wherein the vehicle includes a plurality of speakers, and wherein said entertainment device generates sound and is in communication with the plurality of speakers to broadcast the sound.

8. The recording apparatus of claim 1, further comprising a global positioning system housed in said frame, the global positioning system being operable to calculate location data and being in communication with said recording media to provide location data to said recording media.

9. The recording apparatus of claim 8, wherein said recording media is a digital memory unit and said location data and said one or more input data are relatedly stored.

10. The recording apparatus of claim 9 further comprising a search engine in communication with said recording media, said search engine operable to search said recording media for at least one of said location data and said one or more input data.

11. The recording apparatus of claim 1, further comprising a secondary data input in communication with said recording media to provide at least one secondary parameter to said recording media.

12. The recording apparatus of claim 11, wherein said recording media is a digital memory unit and said secondary data and said one or more input data are relatedly stored thereon.

13. The recording apparatus of claim 11, wherein said secondary data and said one or more input data are relatedly stored on a time basis.

14. The recording apparatus of claim 12, wherein said secondary data is traffic velocity information.

15. The recording apparatus of claim 12, wherein said secondary data is an event identification code.

16. The recording apparatus of claim 15, wherein said event identification code identifies a case and ticket number.

17. The recording apparatus of claim 16, wherein said event identification code further includes an indication to keep or not keep said associated one or more input data.

18. The recording apparatus of claim 16, wherein said event identification code further includes a designation to identify a suspect involved with said event.

19. The recording apparatus of claim 12, wherein said secondary data is time data

20. The recording apparatus of claim 1, further comprising a clock housed in the frame and in communication with said recording media to transmit time data to said recording media.

21. The recording apparatus of claim 19, wherein said recording media is a digital memory unit and said recording media associates the time data and the video data, and further comprising a search engine in communication with said recording media and operable to search said recording media for at least one of the time data and the video data.

22. The recording apparatus of claim 1, wherein said input device is a wireless device.

23. The recording apparatus of claim 22, wherein said wireless device is a portable camera unit carried by an operator.

24. The recoding apparatus of claim 2, wherein said video input data is provided by a 360 degree camera.

25. A recording apparatus for mounting in a vehicle having an interior console, the apparatus comprising:
a frame mountable about the interior console and housing an entertainment system;
a recording media housed in the frame and operable to store audio/video data; and
an audio/video input in communication with said recording media to provide said audio/video data to said recording media.

26. The recording apparatus of claim 25, wherein the console has a double-din aperture, and wherein the frame is mountable in the double-din aperture.

27. The recording apparatus of claim 25, wherein the vehicle includes a plurality of speakers, and wherein the entertainment system generates sound and is in communication with the plurality of speakers to broadcast the sound.

28. The recording apparatus of claim 25, wherein said recording media is a digital memory unit.

29. The recording apparatus of claim 28, further comprising:
a global positioning system housed in the frame and operable to calculate location data, the global positioning system being in communication with said recording media to transfer the location data to said recording media, said recording apparatus associating the location data and the audio/video data.

30. The recording apparatus of claim 29 further comprising:
a search engine in communication with said recording media and operable to search said recording media for at least one of the associated location data and the audio/video data.

31. The recording apparatus of claim 29, further comprising:
a vehicle status data input in communication with said recording media to receive vehicle status data and to transfer the vehicle status data to said recording media, said recording media associating the vehicle status data and the audio/video data.

32. The recording apparatus of claim 29, further comprising:
a traffic velocity recording apparatus input in communication with said recording media to receive traffic velocity data and to transfer the traffic velocity data to said recording media, said recording media associating the traffic velocity data and the audio/video data.

33. The recording apparatus of claim 29, further comprising:
a clock housed in the frame and in communication with said recording media to transmit time data to said recording media, said recording media associating the time data and the audio/video data.

34. A recording apparatus for mounting in a vehicle, the apparatus comprising:
a digital memory unit operable to store audio/video data;
a global positioning system operable to calculate location data and being in communication with the digital memory unit to transfer the location data to the digital memory unit, the digital memory unit associating the location data and the audio/video data.

35. The recording apparatus of claim 34, further comprising:
a vehicle status data input in communication with the digital memory unit to receive vehicle status data and to transfer the vehicle status data to the digital memory unit, the digital memory unit associating the vehicle status data and the at least one of the location data and the audio/video data.

36. The recording apparatus of claim 34, further comprising:
a traffic velocity recording apparatus input in communication with the digital memory unit to receive traffic velocity data and to transfer the traffic velocity data to the digital memory unit, the digital memory unit associating the traffic velocity data and the at least one of the location data and the audio/video data.

37. The recording apparatus of claim 34, further comprising:
a clock in communication with the digital memory unit to transmit time data to the digital memory unit, the digital memory unit associating the time data and the at least one of the location data and the audio/video data.

38. A recording apparatus for mounting in a vehicle, the apparatus comprising:
a digital memory unit operable to store audio/video data;
a traffic velocity recording apparatus input in communication with the digital memory unit to receive traffic velocity data and to transfer the traffic velocity data to the digital memory unit, the digital memory unit associating the traffic velocity data and the audio/video data.

39. The recording apparatus of claim 34, further comprising:
a vehicle status data input in communication with the digital memory unit to receive vehicle status data and to transfer the vehicle status data to the digital memory unit, the digital memory unit associating the vehicle status data and the at least one of the traffic velocity and the audio/video data.

40. The recording apparatus of claim 34, further comprising:
a clock in communication with the digital memory unit to transmit time data to the digital memory unit, the digital memory unit associating the time data and the at least one of the traffic velocity data and the audio/video data.

41. A recording apparatus for mounting in a vehicle, the apparatus comprising:
a digital memory unit operable to store video data;
a vehicle status data input in communication with the digital memory unit to receive vehicle status data and to transfer the vehicle status data to the digital memory unit, the digital memory unit associating the vehicle status data and the video data.

42. The recording apparatus of claim 41, further comprising:
a clock in communication with the digital memory unit to transmit time data to the digital memory unit, the digital memory unit associating the time data and the at least one of the vehicle status data and the video data.

43. A method of cataloging data, the method comprising:
providing a recording apparatus including a frame mountable in a vehicle, a digital memory unit housed in the frame and operable to store audio/video data, an audio/video input in communication with the digital memory unit to provide the audio/video data;
providing a global positioning system in communication with the digital memory unit;
utilizing the global positioning system to calculate location data;
associating and storing the location data and the audio/video data, on the digital memory unit.

44. The method of claim 43 further comprising:
providing a search engine in communication with the digital memory unit; and
searching information stored on the digital memory unit with said search engine for at least one of the location data and the audio/video data.

45. The method of claim 43, wherein the recording apparatus includes a secondary data input in communication with the digital memory unit to provide secondary data to the digital memory unit.

46. The method of claim 45 further comprising associating the secondary data and the at least one of the location data and the audio/video data.

47. The method of claim 45, wherein said secondary data is traffic velocity information.

48. The method of claim 45, wherein said secondary data is date-time information.

49. The recording apparatus of claim 4, wherein said digital memory unit historically tracks its accumulated storage time.

50. The recoding apparatus of claim 2, wherein said video input data is provided by a camera having a mirror option for rear viewing.

51. A recording apparatus for mounting in the interior of a vehicle having a console, the apparatus comprising:
a frame mountable about the console;
a recording media housed in the frame and operable to store audio/video data;
an audio/video input in communication with said recording media to provide said audio/video data to said recording media;
wherein said recording apparatus provides pre-event recording.

52. A recording apparatus for mounting in the interior of a vehicle having a console, the apparatus comprising:
a frame mountable about the console;
a recording media housed in the frame and operable to store audio/video data;
an audio/video input in communication with said recording media to provide said audio/video data to said recording media;
said recording apparatus providing dual channel recording on said recording media.
